(19) United States
(12) Patent Application Publication
(10) Pub. No.: US 2017/0027339 A1
(43) Pub. Date: Feb. 2, 2017

(54) COOLER HAVING A TRANSPARENT DISPLAY

(71) Applicant: LG ELECTRONICS INC., Seoul (KR)

(72) Inventors: Myungwhun CHANG, Seoul (KR); Sungwook HAN, Seoul (KR); Donghyun KIM, Seoul (KR); Kukho BAE, Seoul (KR)

(21) Appl. No.: 15/221,750

(22) Filed: Jul. 28, 2016

Related U.S. Application Data
(63) Continuation of application No. 14/794,064, filed on Jul. 8, 2015.

(30) Foreign Application Priority Data
Feb. 3, 2015 (KR) 10-2015-0016571

(51) Int. Cl. A47F 3/04; F25D 23/02; G02B 5/02; G09F 9/33; F21V 14/08; F21V 14/02; G09F 9/35; A47F 11/06; F21V 23/04

(52) U.S. Cl. CPC A47F 3/0434; A47F 3/0478; A47F 3/0486; A47F 11/06; F25D 23/028; G02B 5/0278; G02B 5/0242; F21V 23/0471; F21V 14/08; F21V 14/02; G09F 9/35; G09F 9/33; F25D 2400/36; G09F 2023/0033

(57) ABSTRACT

A cooler having a transparent display is provided. The cooler may include a body having a storage space configured to receive products therein, a door installed on the body to open and close the storage space; and a display assembly installed in the door. The display assembly may include a transparent display pane, a dispersion panel arranged at a rear of the transparent display panel and configured to scatter light, which is incident upon the dispersion panel, a first light source configured to radiate light to an inside of the dispersion panel, wherein transparency of the dispersion panel is controlled via the first light source depending on a distance between the cooler and an object located outside the cooler, and a second light source configured to radiate light to control brightness in the storage space, depending on the distance between the object and the cooler.

### CROSS-REFERENCE TO RELATED APPLICATION(S)

This application is a continuation-in-pail of U.S. patent application Ser. No. 14/794,064 filed on Jul. 8 2015, which, pursuant to 35 U.S.C. §119(a), claims priority to Korean Patent Application No. 10-2015-0016571 filed in Korea on Feb. 3, 2015, the entire contents each of which are hereby incorporated by reference in its entirety.

### BACKGROUND

1. Field

A cooler for keeping products in a cool condition, and more particularly, a having a transparent display are disclosed herein.

2. Background

A walk-in cooler or showcase is generally installed in a shop to display products, which will be sold, in a refrigerated state. Such a cooler has a large-sized body that may receive more products therein, if possible, to efficiently use a space of the shop, and also has a large-sized door to open and close the body. The door generally includes a large-sized glass to allow inner products to be easily viewable. Therefore, a transparent display panel is applied to the glass of the door to utilize the space formed in the door.

A conventional fiat display panel, for example, a LCD (Liquid Crystal Display) or OLED (Organic Light-Emitting Diode) panel is structurally opaque, whereby a clear picture image may be provided to users. On the other hand, display panels having a transparent body have recently been developed, and are referred to herein as “transparent display panels”. The transparent display panel allows a user to see an object at a rear of the panel together with information displayed on the panel due to its transparent body. Also, a third party located at an opposite side of the user may also see the information displayed on the panel.

The transparent display panel may allow a user to see products in a cooler while providing information on the products in the cooler or an advertisement if the transparent display panel is applied to the cooler. Therefore the cooler having a transparent display may perform an additional function of promoting purchasing by a user while performing a basic function of keeping products in a fresh condition.

In more detail, the user is actually encouraged to purchase products in the cooler by information displayed at a location spaced apart from the cooler at a certain distance that is, an advertisement and detailed information on the products kept in the cooler. Therefore, the displayed information should be seen well or easily viewable by the user located at a distance from the cooler. Meanwhile, the user is concentrated on information on the products and actual products in a state in which the user is close to the cooler. Therefore, if the cooler provides an advertisement or information, which is not directly related to the products kept in the cooler, such information should be seen well or easily viewable by the user located to be far or farther away from the cooler. However, the transparent display in the aforementioned conventional cooler cannot clearly provide the displayed information to the user located to be far or farther away from the cooler due to its transparency. Therefore, in order to make maximum use of the cooler having a transparent display, it is required or necessary to allow the user to selectively see information of the transparent display or the products in the cooler depending on the distance between the user and the cooler.

### BRIEF DESCRIPTION OF THE DRAWINGS

Embodiments will be described in detail with reference to the following drawings in which like reference numerals refer to like elements, and wherein:

FIG. 1 is a perspective view illustrating a cooler having a transparent display according to an embodiment;

FIG. 2 is a perspective view illustrating a state in which a door s removed from the cooler of FIG. 1;

FIGS. 3 and 4 are partial cross-sectional views taken along line of FIG. 1 to illustrate a transparent display assembly according to an embodiment;

FIG. 5 is a partial cross-sectional view illustrating a dispersion panel of a transparent display assembly according to an embodiment;

FIG. 6 is a plane view illustrating a dispersion panel according to an embodiment, in a state in which light is not radiated from a light source;

FIG. 7 is a plane view illustrating a dispersion panel according to an embodiment, in a state in which light is radiated from a light source;

FIG. 8 is a perspective view illustrating the cooler according to an embodiment when a user is spaced apart from the cooler at a predetermined distance or more:

FIG. 9 is a perspective view illustrating the cooler according to an embodiment when a user is closer to the cooler than a predetermined distance or less;

FIG. 10 is a cross-sectional view of a door illustrating a display assembly including a second light source;

FIGS. 11 to 15 are cross-sectional views illustrating other examples of the display assembly of FIG. 10;

FIGS. 16A and 16B are cross-sectional views of a door illustrating a display assembly including a movable dispersion panel;

FIGS. 17, 18A, and 18B are cross-sectional views illustrating other examples of the display assembly of FIGS. 15A and 16B;

FIGS. 19A and 19B are cross-sectional views of a door illustrating a display assembly including a first movable light source;

FIG. 20 is a cross-sectional view illustrating another example of the display assembly of FIGS. 19A and 19B;

FIGS. 21A and 21B are cross-sectional views illustrating a display assembly including a partition;

FIG. 22 is a cross-sectional view illustrating another example of the display assembly of FIGS. 21A and 21B;

FIGS. 23 to 25 are cross-sectional views illustrating various examples of doors, each of which includes a display assembly;

FIGS. 26A and 26B are perspective views illustrating operation of the cooler depending on a distance from a user;

FIGS. 27A and 27B are perspective views illustrating a further example of the cooler and operation thereof;

FIG. 28 is a perspective view illustrating another example of the cooler and operation thereof; and

FIGS. 29A and 29B are perspective views illustrating yet another example of the cooler and operation thereof.

### DETAILED DESCRIPTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated, in general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context. Terms such as “comprise” “include” or “has” are used herein and should be understood that they are intended to indicate an existence of several components, functions or steps disclosed in the specification, and it is also understood that greater or fewer components, functions, or steps may likewise be utilized. Also, for the same reason, it is to be understood that this application includes combination of features, numbers, steps, operations, elements, parts, etc., which are partially omitted from combination of features, numbers, steps, operations, elements, and parts, which are described using the aforementioned terminologies, as far as it does not depart from intention of the present invention.

A cooler described in this specification may include all commercial refrigerating devices, such as a walk-in cooler, a showcase, and a chiller, for example. However, it will easily be apparent to those skilled in the art that configuration and operation according to the embodiments disclosed herein may equally be applied to all refrigerating devices for home use, such as a refrigerator and a wine cooler, for example, and is not limited to commercial refrigerating devices only.

Also, the cooler may be used for activities related to purchasing of products in most cases. Therefore, “users” of the cooler may correspond to potential “purchasers” except staffs of a shop For this reason, “users” refer to potential “purchasers” in the following description. Further, users may be recognized as simple objects, which are located at the outside of the cooler or located in front of the cooler, by the cooler from a control point of view. Therefore, in the following description,“users” may also mean “objects”.

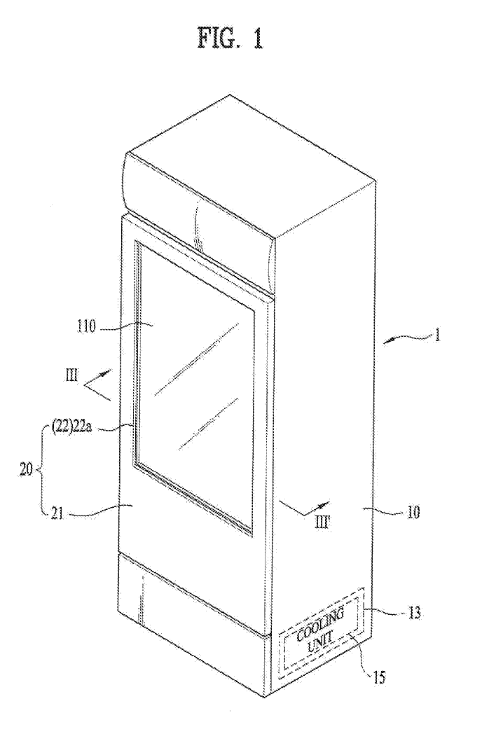

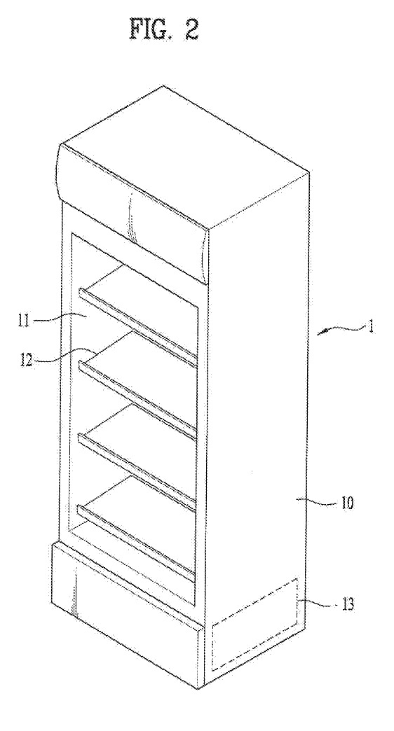

FIG. 1 is a perspective view Illustrating a cooler having a transparent display according to an embodiment. FIG. 2 is a perspective view illustrating a state in which a door is removed from the cooler of FIG. 1.

The cooler or showcase 1 according to an embodiment may include a body 10. The body 10 may have a predetermined space 11 formed therein, as shown in FIG. 2. The body 10 may store products which will be sold, in the space 11. In more detail, a plurality of racks 12 may be installed in the space 11. The products may be arranged on the plurality of racks 12, whereby the products may be supported by the plurality of racks 12 and stably stored in the space 11.

The cooler 1 may maintain the products in a cool condition to keep the products fresh for a long time. For such cooling, various methods may be provided. For example, the products may be directly cooled using a cooling member, such as a them) element. Alternatively, the products may be indirectly cooled using cool air. The cooler 1 have been a large-sized space 11, as shown, and store more products, which will be cooled, therein. The cooler 1 may be configured to supply the cool air into the space 11 to effectively cool the large-sized space 11 and more products. That is, the cooler 1 may include a cooling unit or device 15 configured to supply the cool air to the space 11. The cooling unit 15 may use a cooling cycle, and may include various elements that perform the cooling cycle. For example, the cooling unit 15 may include an expansion valve, a compressor, a heat exchanger, and a refrigerant pipe. The refrigerant pipe may connect the expansion valve, the compressor, and the heat exchanger with one another and transport a phase-changed refrigerant. The cooled refrigerant may be heat-exchanged with air by the heat exchanger, and the cooled air may be supplied into the space 11 through a duct formed in the body 10. The cooled air supplied to the space 11 may cool the products through heat exchange with the products in the space 11, and the cooled air may be continuously supplied into the space 11 and maintain the products in a cooled condition. Also, a heat insulator may be arranged in the body 10 to avoid heat loss to air around the cooler 1. The above cooling units may be arranged in a machine chamber 13 formed in the cooler 1, as shown in FIGS. 1 and 2. However, the cooling unit 15 and the machine chamber 13 for receiving the cooling unit 15 may be arranged at another part or portion of the cooler 1 depending on a design of the cooler 1.

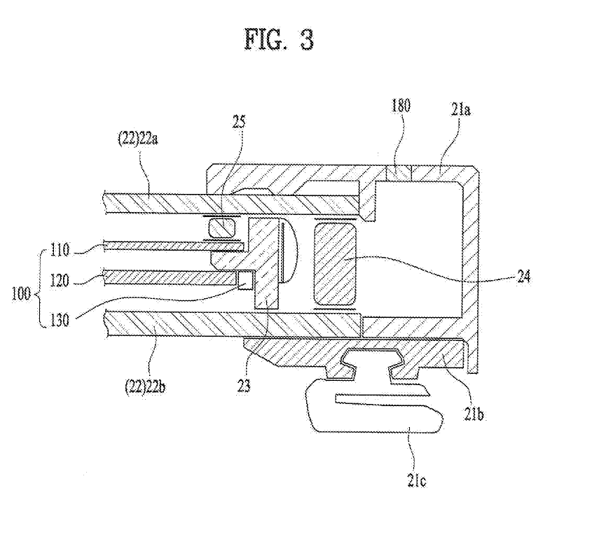

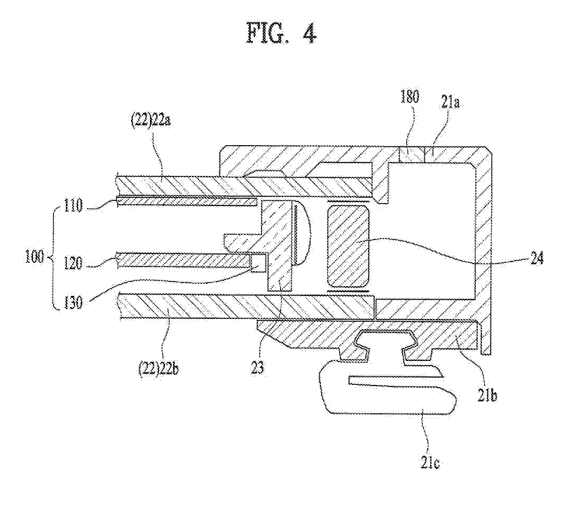

The cooler 1 may have a door 20 installed in or on the body 10. The door 20 may be arranged at an opened part or portion of the space 11, and may open or close the space 11. The door 20 may be rotatably installed in or on the body 10 to actively open or close the space. For example, one side of the door 20 may be installed in or on the body 10 using hinges. A user who uses the door 210 may open the space 11 and access the products. The user may close the space 11 using the door 20 to prevent the cool air from leaking out and keep the products in a cool condition. Also, as the cooler 1 may be installed in a shop to sell the products, the cooler 1 should be installed to allow the products to be well seen or easily viewable by a user, that is, a purchaser. Therefore, as shown in FIGS. 3 and 4, the door 20 may include a large-sized transparent glass 22 to allow the products kept in the cooler 1 to be well seen or easily viewable by the user.

Referring to FIGS. 3 and 4, the door 20 may include a frame 21. The frame 21 may include front and rear frames 21a and 21b configured to form a space in which the glass 22 may be inserted. Also, the door 20 may have a gasket 21c installed at the rear frame 21b adjacent to the body 10 of the cooler 1. The gasket 21c may be interposed between the door 20, that is, the rear frame 21b and the body 10, and may be directly in contact with the body 10 instead of the frame 21. The gasket 21c may be made of a deformable elastic material. The gasket 21c may be directly in contact with the body 10 when the door 20 closes the space 11, and may be adhered to the body 10 hie being deformed. Therefore, the gasket 21c may effectively prevent the cool air from being leaked out from the space 11. Moreover, the gasket 21c may include a magnet therein. The body 11 may include a magnet at a contact part or portion with the gasket 21c, or may be made of a material that may magnetize the contact part. In this cases when the door 20 is closed the gasket 21c may be adhered to the body 10 or the magnet of the body 10, and may be adhered to the body 10 to more effectively prevent the cool air from being leaked out.

Generally, the door 20 may have a glass 22 made of a single member. However, in order to increase an insulation effect as shown, the glass 22 may include dual glasses 22a and 22b. In more detail, the door 20 may have front and rear glasses 22a and 22b inserted between the front and rear frames 21a and 21b. The front glass 22a may be adjacent to the front frame 21a, and may face an outside of the cooler 1. Also, the rear glass 22b may be adjacent to the rear frame 21b, and may face an inside of the cooler 1, that is, the space 11. The front and rear glasses 22a and 22b may be spaced apart from each other at a predetermined interval, whereby a predetermined space may be formed between the glasses 22a and 22b. Air may exist within the space, and have a heat conductivity which is significantly low. Therefore, the door 20 may be substantially made of dual glasses 22a and 22b and a heat insulation layer made of air and arranged between the glasses 22a and 22b. For this reason, the door 20 may have a high heat insulation effect that allows the products in the cooler 1 to be well seen or easily viewable by a user through the large-sized glass 22 and keeps the products in a cool condition for a long time. Meanwhile, if foreign substances, such as dirt, are inserted to or in the space between the dual glasses 22a and 22b, transparency of the glasses 22a and 22b may be reduced, and the products in the cooler 1 may not be seen by the user. In particular, if water permeates into the space between the dual glasses 22a and 22b, water in the air may be condensed on the glasses 22a and 22b due to a temperature difference with the outside, and the transparency of the glasses 22a and 22b may deteriorate in a same manner as the foreign substances. Therefore, the door 20 may have a seal 24 arranged between the glasses 22a and 22b. The seal 24 may seal the space between the glasses 22a and 22b, and may effectively prevent the foreign substances or water from permeating into the space.

Also, the cooler 1 may have a transparent display assembly 100 configured to provide a user with predetermined information. The transparent display assembly 100 may provide an advertisement on a specific product or information of the products in the cooler 1, and in addition, may provide various kinds of information to the user. The transparent display assembly 100 may allow the user to see the products in the cooler 1 due to its transparent body while providing the user with the above information. In order to use this characteristic of the transparent display assembly 100, the transparent display assembly 100 may be installed in the door 20 so as to be well seen or easily viewable by the user. Moreover, the transparent display assembly 100 may be installed in the transparent glass 22 of the door 20 to maintain a transparency required to show both predetermined information and the products to the user. As the transparent display assembly 100 may not have a high structural strength, if the assembly 100 is arranged outside the glass 42, the assembly 100 may be easily damaged. Meanwhile, as described above, t he predetermined space may be formed between the dual glasses 22a and 22b. Therefore, the transparent display assembly 100 may be received in the space between the dual glasses 22a and 22b, as shown in FIGS. 3 and 4.

In more detail, the transparent display assembly 100 may include a transparent display panel 110. The transparent display panel 110 may include a LCD (Liquid Crystal Display), an OLED (Organic Light-Emitting Diode), or an Electro-Wetting Display, for example. These panels 110 may be categorized into emissive transparent display panels and passive transparent display panel in accordance with a scheme for realizing transparency. A transparent LCD is a passive transparent display panel, and a transparent OLED is an emissive transparent display panel. As the principle of these transparent display panels 110 is already known, it will be omitted in the following description.

The transparent display panel 110 may be arranged to adjoin the front glass 22a, whereby information displayed for the user may be transferred or transmitted to the user. However, in this case, when the front glass 22a is damaged, the transparent display panel 110 adjacent to the front glass 22a may be damaged together with the front glass 22a. Therefore, as shown in FIG. 3, the transparent display panel 110 may be spaced apart from the front glass 22a at a predetermined interval. To this end, a spacer 25 may be interposed between the transparent display panel 110 and the front glass 22a as shown. On the other hand, although the space between the dual glasses 22a and 22b is sealed by the seal 24, as described above, air may exist in the space together with some water. In particular, as the front glass 22a is directly in contact with the external air having a relatively high temperature, residual water may easily be condensed inside the front glass 22a within the space between an inner surface of the front glass 22a and the transparent display panel 110. Therefore, the user may not easily see the information displayed on the transparent display panel 110. For this reason, as shown in FIG. 4, the transparent display panel 110 may be attached to the front glass 22a. In more detail, the transparent display panel 110 may be adhered to the inner surface of the front glass 22a. For such adhesion, various adhering means including an adhesive may be used. A space to allow the air including water or condensation of such water does not exist between the transparent display panel 110 and the front glass 22, which are adhered to each other. Therefore, on the adhered panel 11, display and provision of information is not affected by water condensation between the dual glasses 22a and 22b.

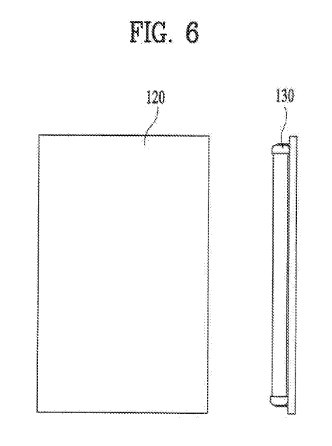

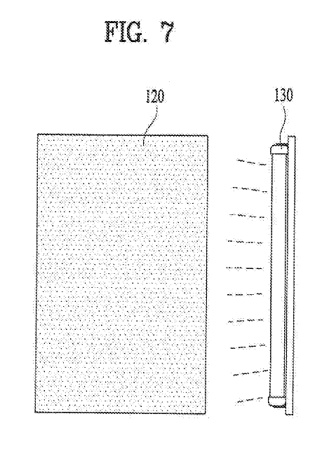

The transparent display assembly 100 may further include a dispersion panel 120 arranged at a rear of the transparent display panel 110. Also, the transparent display assembly 100 may include a light source 130 to radiate light toward the dispersion panel 120. The light source 130 may be configured so as to radiate light to the inside of the dispersion panel 120. The light source 130 may be arranged at any position as long as the light source 130 may radiate light to the inside of the dispersion panel 120. In more detail, the light source 130 may be arranged around the dispersion panel 120 and, in order to achieve more effective light radiation be arranged at a side of the dispersion panel 120 A support 23 may be arranged between the dual glasses 22a and 22b, whereby the dispersion panel 120 and the light source 130 may be installed at the aforementioned locations. That is, the dispersion panel 120 and the light source 130 may be installed on the support 23. Also, the support 23 may support the panel 110 as well as the dispersion pane, 120 and the light source 130. The dispersion panel 120 may be configured to control its transparency depending on whether light is radiated toward the side of the dispersion panel 120. The light source 130 may include a lamp, and may be configured to radiate light to the side of the dispersion panel 120. As shown in FIGS. 6 and 7, the light source 130 may extend along the side of the dispersion panel 120 to uniformly radiate light toward the side of the dispersion panel 120. The light source 130 may include Light Emitting Diodes (LEDs). For example, the light source 130 may be a module including a plurality of LEDs. The light source 130 may includes a Printed Circuit Board (PCB) on which LEDs are installed. The light source 130 may include colored LEDs to emit light of at least one color of red blue, green, etc. or white LEDs. The light source 130 may be of a Chip On Board (COB) type. The COB-type light source may be configured such that LEDs are directly combined with a board. Therefore, the COB-type light source may simplify a manufacturing process. Further, it may reduce resistance and energy loss generated thereby. That is, it means increase in power efficiency of the light source 130.

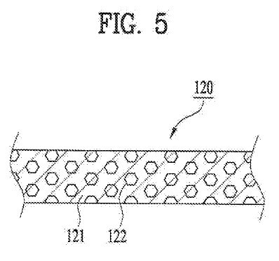

The dispersion panel 120 may be configured to scatter light incident upon its inner side through its side, thereby controlling its transparency. In more detail, the dispersion panel 120 may include a body 121 made of a first material, and particles 122 made of a second material different from the first material, as shown in FIG. 5. Each particle 122 may be a fine particle having a diameter of several micrometers, and may be included in the body 121. The first material and the second material may be transparent materials. However, the first and second materials may have respective refractive indexes different from each other. Therefore, if the light source 130 radiates light toward the side of the dispersion panel 120 the light incident upon the side of the dispersion panel 120 may move through total reflection within the dispersion panel 120. If this light encounters the particles 122 during movement, the light may be scattered due to the refractive index of the particles 122 which is different from the refractive index of the body 121. Therefore as shown in FIG. 7, if light is radiated toward the side of the dispersion panel 120 by the light source 130, transparency of the dispersion panel 120 may be deteriorated by scattering of the light generated therein. However, if the light source 130 does not radiate light toward the side of the dispersion panel 120 scattering of the light incident upon the dispersion panel 120 may not be generated. Therefore, as shown in FIG. 6, the dispersion panel 120 may maintain a transparent state due to the body 121 and the particles 122, which are made of the transparent first and second materials. That is, if the light source 130 radiates light toward the dispersion panel 120, in particular, the side of the dispersion panel 120, transparency of the dispersion panel 120 may deteriorate, whereas if the light source 130 does not radiate light toward the dispersion panel 120, in particular, the side of the dispersion panel 120 the dispersion panel 120 may maintain a transparent state due to the transparency of its materials. The light quantity or intensity of the light source 130 may be adjusted and transparency of the dispersion panel 120 may be changed according to such a light quantity or intensity. In more detail, as the light quantity or intensity of the light source 130 gradually increases, transparency of the dispersion panel 120 may gradually decrease. Therefore, whiles the light source 130 is enlarged and thus the light quantity or intensity thereof continuously increases, transparency of the dispersion panel 120 may decrease and the dispersion panel 120 may be changed from a transparent state finally to an opaque state. Alternatively, in more detail, the dispersion panel 120 may include a layer which performs the same function as the particles 122, instead of the particles 122. The layer may be made of a second material having a different refractive index from that of the first material of the body 121. The layer may be provided on the surface of the body 121, for example the front or rear surface of the body 121, or be provided on both surfaces of the body 121. For example, the layer may include the above-described particles 122 so as to have a different refractive index from that of the material of the body 121. Since the layer executes the same function as the above-described particles 122, the dispersion panel 120 including such a layer has the same function as described above and a detailed description thereof will thus be omitted.

The transparent display assembly 100 may include a proximity sensor 180 that measures a distance between a user and the cooler 1. In the shop the user may approach toward a front of the cooler 1 to purchase a product, and the proximity sensor 180 may be installed in the door 20 arranged at the front of the cooler 1 As shown, as the front frame 21a of the door 20 is exposed to the outside of the cooler 1, and thus, faces the user, the proximity sensor 180 may be installed in the front frame 21a. However, if the distance between the user and the cooler 1 is measured exactly, the proximity sensor 180 may be installed anywhere on the cooler 1 in addition to the door 20. As discussed in a description of an operation of the cooler 1 according to this embodiment, which will be described hereinbelow, the distance between the user and the cooler 1, which is measured by the proximity sensor 180, may be used to control the transparency of the dispersion panel 130, whereby the distance may be a basis for optimized control of the cooler 1.

Operation of the cooler 1 will now be described based on the aforementioned structure of the cooler 1.

As the cooler 1 may be installed in a commercial facility, that is, a retailer or a wholesaler, the cooler 1 may be configured to stimulate a purchasing desire of a user, that is, a potential purchaser, in addition to a basis function of keeping products in a cool condition. As the cooler 1 may include the transparent display assembly 100, as described above, the cooler 1 may allow the user to see the products therein while providing an advertisement or information of the products therein. The advertisement may be related to the products kept in the cooler 1 or another product not the products kept in the cooler 1. Therefore, the cooler 1 may perform a function of guiding purchasing of the user and at a same time perform an additional function for exposing or showing an advertisement of a specific product to the user.

In the meanwhile, when the user, that is, a potential purchaser is located farther away from the cooler 1, the user may be guided to the cooler 1 by product information displayed by the transparent display assembly 100 to purchase the product. Also, as the user is substantially concentrated or focused on information on the product and the actual product in a state in which the user is close to the cooler 1, the advertisement should be well seen or easily viewable by a user who is located to be far away or farther from the cooler 1 regardless of an advertisement of a specific product or the products kept in the cooler 1. That is, it is important that the products in the cooler 1 should be well seen or easily viewable by a user who is located close to the cooler 1, whereas it is important that an advertisement or another information, which may be provided from the cooler 1 using the transparent display assembly 1, should be well seen or easily viewable by a user who is located to be far or farther away from the cooler 1. Therefore, in order to use the cooler 1 having the transparent display assembly 100 more effectively, the cooler 1 needs to selectively provide a user with information, that is, an advertisement and another information through the transparent display assembly 100 or an appearance of the product, which will be actually sold, through the glass 22 of the door 20, in accordance with a relative distance between the user and the cooler 1. For this reason, the cooler 1 may be configured to allow the user to selectively see information through the transparent display assembly 100 in accordance with the distance between the user and the cooler 1. In other words, the cooler 1 may allow the user to selectively see the products in the cooler 1 in accordance with the distance between the user and the cooler 1. Also, the user may approach the door 20 to see the products or take out the products in most cases, whereby the distance between the user and the cooler 1 may be substantially a distance between the user and the door 20. Based on this concept and principle the operation of the cooler 1 will be described in more detail hereinbelow.

First, if a user enters the shop to purchase a product, the user may be located at a predetermined distance from the cooler 1 or the door 20 of the cooler 1, or may be located to be far or farther away from the predetermined distance. That is, the distance between the user and the cooler 1 or the distance between the user and the door 20 of the cooler 1 may be the predetermined distance or less. The predetermined distance may be a distance that allows the user not to identify the products in the cooler 1 clearly with the naked eye. However, the predetermined distance may be varied depending on various factors, such as a condition in the shop, types of products, or an advertisement which is provided. Although the predetermined distance may be measured by various methods according to this embodiment, the predetermined distance may be measured by the proximity sensor 180 installed in the cooler 1 as described above.

The proximity sensor 180 may continue to or continuously measure the distance between the user and the cooler 1 or the door 20 and may transfer the measured distance to a controller (not shown) installed in the cooler 1 as an electric signal. The controller may compare the received distance with a predetermined distance which is preset or predetermined. If the controller determines that the received distance is more than the predetermined distance, the controller may turn on the light source 130. In other words, if the user is located at a predetermined distance from the cooler 1 or the door 20 or located to be far away or farther from the predetermined distance, the light source 130 may be configured to be turned on to radiate light. Control of the cooler 1, which will be described later, may be executed by the controller. Therefore, characteristics regarding control of all operations may be described as characteristics of the controller.

If the user is located at the predetermined distance or located to be far or farther away from the predetermined distance, the cooler 1, in particular, the transparent display assembly 100 may provide the user with other information which is not related to the products, for example, an advertisement of another product not the products kept in the cooler 1. That is, as the user does not have an exact intention to purchase the product yet, such information may be provided. However, information directly related to the products for example, an advertisement of the products kept in the cooler 1 and a price and quality of the products kept in the cooler 1 may be provided to the user to more actively promote purchase of the user. If the cooler 1 provides other information different from the aforementioned information, the aforementioned information may be provided selectively when it is determined that the user is located to be more than the predetermined distance away from the cooler 1. If the controller determines that the received distance is more than the predetermined distance during the aforementioned display, the controller may control the transparent display assembly 100 to display the aforementioned display information.

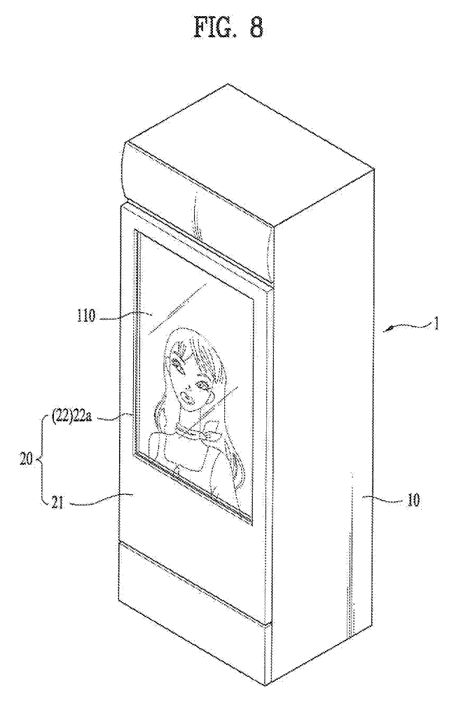

If the light source 130 radiates light, the dispersion panel 120 may be configured to have decreased transparency. As described above, if the light source 130 radiates light to the side of the dispersion panel 120, the light incident upon the side of the dispersion pan& 120 may move or shine within the dispersion panel 120 and may be scattered due to different refractive indexes of the body 121 and the particles 122 when the light encounters the particles 122 during movement. Therefore, as shown in FIG. 7, if the light source 130 radiates light, transparency of the dispersion panel 120 may be deteriorated by scattering of the light generated therein. If the dispersion panel 120 has decreased transparency, the products in the cooler 1 may be covered or veiled by the dispersion panel 120, whereby the products in the cooler 1 may not be seen by the user. That is, the user cannot see the products in the cooler 1 clearly through the glass 22 due to the dispersion panel 120 which becomes substantially opaque. Instead, as shown in FIG. 8, as the dispersion panel 120 has decreased transparency, information displayed on the panel 110 may be more clearly seen by the user. That is, the dispersion panel 120, which is substantially opaque may provide the transparent display panel 110 with a dark background, and the information on the panel 110 may be seen clearly by the user as compared with the dark background. In contrast, the transparent display in the conventional cooler cannot provide a user located to be far away from the cooler, with information which is clearly displayed, due to its transparency.

On the other hand, if the user approaches the cooler 1, the user may be located closer to the cooler 1 or the door 20 of the cooler 1 than the predetermined distance. That is, the distance between the user and the cooler 1 or the door 20 of the cooler 1 may be less than the predetermined distance. The user may be guided by information provided by the cooler 1, in particular, the transparent display assembly 100, to purchase the product or may approach the cooler 1 to identify the product more exactly or easily. On the other hand, the user may approach the cooler 1 due to several other reasons.

The proximity sensor 180 may continue to or continuously measure the distance between the user and the cooler 1 or the door 20, and the controller may continue to or continuously compare the distance received from the proximity sensor 180 with the predetermined distance which is preset or predetermined. If the controller determines that the received distance is less than the predetermined distance, the controller may turn off the light source 130. That is, if the user is closer to the cooler 1 or the door 20 than the predetermined distance, the light source 130 may be configured to be turned off so as not to radiate light.

In the meanwhile if the user is located to be less than the predetermined distance, it may be regarded that the user is basically interested in the product kept in the cooler 1 or has a purchasing intention with respect to the product. Even though the user is not interested in the product kept in the cooler 1 or does not have the purchasing intention with respect to the product, as the user is located to be close to the cooler 1, it is favorable to attract the attention of the user to the product to purchase the product. Therefore, if the user is located to be less than the predetermined distance, the cooler in particular, the transparent display assembly 100, may provide the user with only information related to the product. On the other hand, as it may be regarded that the user has a purchasing intention with respect to the product kept in the cooler 1, the cooler 1, in particular, the transparent display assembly 100 may not display any information so that the user may concentrate on the actual product. Actually, if the controller determines that the received distance is less than the predetermined distance during the display, the controller may control the transparent display assembly 100 to display the aforementioned information, or may control the transparent display assembly 100 so as not to display any information.

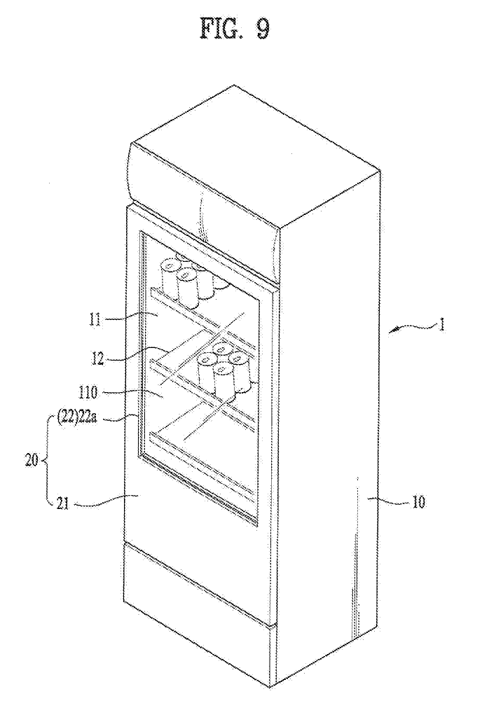

If the light source 130 does not radiate light, the dispersion panel 120 may maintain or be maintained in a transparent state. As described above, although the body 121 and the particles 122 have their respective refractive indexes different from each other, each of the body 121 and the particles 122 is basically made of a transparent material. Therefore, if light does not enter the dispersion panel 120 directly, the dispersion panel 120 does not generate scattering of light. For this reason, as shown in FIG. 6, if the light source 130 does not radiate light, the dispersion panel 120 may continue to maintain the transparent state in the same manner as the glass 22 and the panel 110. As shown in FIG. 9, if the dispersion panel 120 is transparent, the user may see the products kept in the cooler 1 clearly through the transparent glass 22, the panel 110, and the dispersion panel 120. As described above, the transparent display panel 110 cannot easily provide the user located to be far away from the cooler with information, due to its transparency, but the user located to be close to the cooler may easily identify the information on the transparent panel 110. Therefore, even though the transparent display assembly 100 displays the aforementioned predetermined information, this information may be clearly seen to the user who is located to be less than the predetermined distance from the cooler 1.

As described above, since the light quantity or intensity of the light source 130 may be adjusted, as the light quantity or intensity of the light source 130 gradually increases, transparency of the dispersion panel 120 may gradually decrease. Therefore, while the light source 130 is enlarged and thus the light quantity or intensity thereof continuously increases, transparency of the dispersion panel 120 may decrease and the dispersion panel 120 may be changed from a transparent state finally to an opaque state. Such change of the light quantity or intensity may be interlocked with change of a distance between a user and the cooler 1. In more detail, as the distance between the user and the cooler 1 gradually increases, the light quantity or intensity of the light source 130 may gradually increase, transparency of the dispersion panel 120 may gradually decrease and thus the dispersion panel 120 may be changed from the transparent state finally to the opaque state. Further, as the distance between the user and the cooler 1 gradually decreases, the light quantity or intensity of the light source 130 may gradually decrease, transparency of the dispersion panel 120 may gradually increase and thus the dispersion panel 120 may become completely transparent. Moreover, such control of transparency may be applied based on a predetermined distance between the user and the cooler 1. In more detail, as the distance between the user and the cooler 1 gradually increases from the above predetermined distance, the light quantity or intensity of the light source 130 may gradually increase and transparency of the dispersion panel 120 may gradually decrease. On the other hand, as the distance between the user and the cooler 1 gradually decreases from the above predetermined distance, the light quantity or intensity of the light source 130 may gradually decrease and transparency of the dispersion panel 120 may gradually increase.

As is apparent from the aforementioned operation of this embodiment, operation of the light source 130 is determined depending on the distance between the user and the cooler 1 and transparency of the dispersion panel 120 may be controlled depending on the operation of the light source 130. Also, whether the product in the space 11 is seen by the user may be determined depending on a change in transparency. In more detail, if the user approaches the cooler 1, light is not radiated from the light source 130, whereby the dispersion panel 120 becomes transparent, and the user may see the inside of the cooler 1 through the transparent display assembly 100 and the glass 22. Meanwhile, if the user is located to be far away from the cooler 1, light is radiated from the light source 130, whereby the dispersion panel 120 has decreased transparency, and the user may well see or easily view the information displayed by the transparent display assembly 100 instead of seeing the inside of the cooler 1 through the dispersion panel 120. As a result, the cooler 1 may control transparency of the dispersion panel 120 in accordance with the distance between the user and the cooler 1 to allow the user to selectively see the products. In more detail, as described above, as the transparency of the dispersion panel 120 is controlled by radiation of light the cooler 1 may determine whether to operate the light source 130 depending on the distance between the and the cooler 1 to control the transparency of the dispersion panel 120.

The products in the cooler 1 or information of the transparent display assembly 100 may be selectively seen by the user by control of the transparency of the dispersion panel 120 based on the distance between the user and the cooler 1 and control of visibility. Therefore, when the user is located to be far away from the cooler 1, predetermined information may be clearly seen by the user to stimulate the purchasing intention of the user, and when the user is located to be close to the cooler 1 the products in the cooler 1 may be clearly seen by the user to assist product selection by the user. As a result, according to this embodiment, the transparent display assembly 100 may be controlled optimally, whereby efficiency of the cooler 1 may be maximized.

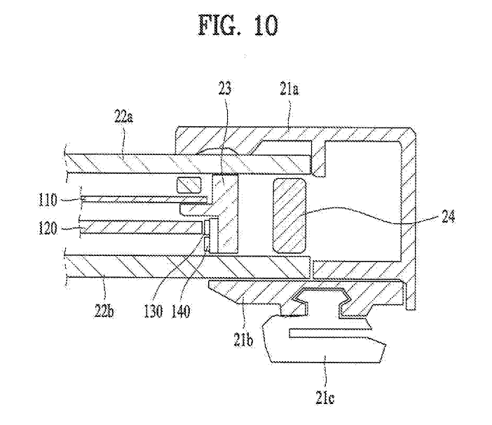

Further, in order to more effectively achieve intended functions, the cooler may include additional components. Such additional components will be described in detail with reference to FIGS. 10 to 29B. The components described above with reference to FIGS. 1 to 9 may be applied to the configuration of the cooler 1 shown in FIGS. 10 to 29B and a detailed description thereof will thus be omitted.

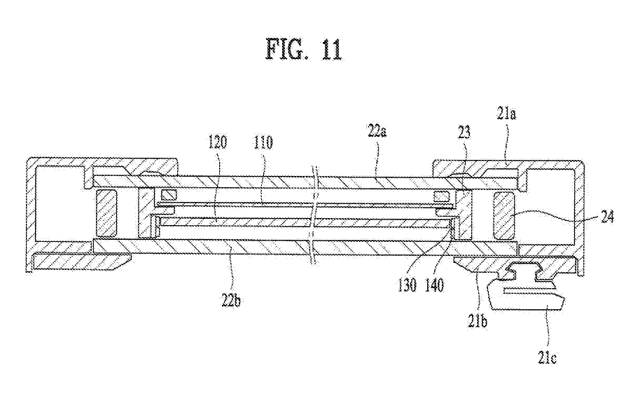

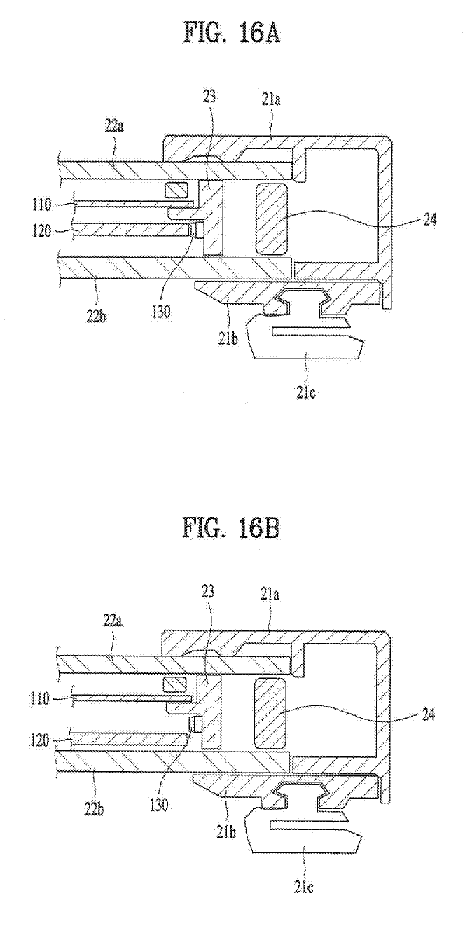

First, FIG. 10 is a cross-sectional view of a door illustrating a display assembly including a second light source FIGS. 11 to 15 are cross-sectional views illustrating other examples of the display assembly of FIG. 10. In order to more effectively show the display assembly, FIGS. 10 to 15 are cross-sectional views taken along line III-III′ of FIG. 1, in the same manner as FIGS. 3 and 4. In the same manner, FIGS. 16 to 22, which will be described later, are cross-sectional views taken along line of FIG. 1.

First, with reference to FIGS. 16A and 16B, the display assembly 100 may include a subsidiary light source 140 in addition to the light source 130. In order to distinguish the subsidiary light source 140 from the above-described light source 130, the subsidiary light source 140 may be referred to as a second light source and the light source 130 may be referred to as a first light source. Further, the second light source 140 may perform a function different from the display assembly 100, more precisely, the dispersion panel 120 and the first light source 130 thereof and thus be distinguished from the display assembly 100. Therefore, it may be described that the cooler 1 itself includes the second light source 140. As exemplarily shown in FIGS. 16A and 16B, the second light source 140 may be installed within the door 20. In more detail, in the same manner as the dispersion panel 120 and the first light source 130, the second light source 140 may be installed on the support 23 and thus be arranged adjacent to the dispersion panel 120 and the first light source 130. The second light source 140 may include a lamp and extend so as to uniformly radiate light. Further, the second light source 140 may have a similar configuration to the configuration of the above-described first light source 130.

Differently from the first light source 130 configured to radiate light toward the dispersion panel 120, the second light source 140 may be configured to radiate light toward other parts of the cooler 1 except for the dispersion panel 120. In more detail, the second light source 140 may be configured to radiate light to the inside of the door 20 and the storage space 11 in the body 10. For this purpose, the second light source 140 may be oriented toward the storage space 11. Therefore, the second light source 140 may be configured to adjust brightness of the inside of the cooler 1, i.e., the storage space 11. In more detail, as described above with reference to FIGS. 8 and 9, if a user is located closer to the cooler 1 than a predetermined distance, the first light source 130 may be turned off and the dispersion panel 120 may maintain a transparent state so that the inside of the cooler 1 may be clearly seen by the user. In contrast, if the user is located closer to the cooler 1 than the predetermined distance, the second light source 140 may be turned on and brightness of the storage space 11 may be increased. Therefore, the inside of the cooler, i.e., the storage space 11 and products stored therein, may be more clearly seen by the user. On the other hand, if the user is located at the predetermined distance from the cooler 1 or located farther away than the predetermined distance from the cooler 1, the first light source 130 radiates light and the dispersion panel 120 may have decreased transparency so that information of the display 110 may be clearly seen by the user. In contrast, if the user is located at the predetermined distance from the cooler 1 or located farther away than the predetermined distance from the cooler 1, the second light source 140 may be turned off and the storage space 11 may have considerably reduced brightness. Therefore, brightness of the storage space 11 does not interfere with information on the display 110 and thereby the user may clearly see the information on the display 110. That is, if the user is located closer to the cooler 1 than the predetermined distance, in order to increase visibility of the inner space of the cooler 1, the second light source 140 may be operated while the first light source 130 is turned off. Further, if the user is located at the predetermined distance from the cooler 1 or located farther away than the predetermined distance from the cooler 1, in order to increase visibility of information on the display 110, the second light source 140 may be turned off while the first light source 130 is turned on. Therefore, operation of the second light source 140 may be determined depending on the distance between the user and the cooler 1, and brightness of the storage space 11 may be adjusted depending on operation of the second light source 140. Consequently, brightness of the storage space 11 may be controlled by the second light source 140 depending on the distance between the user and the cooler 1.

In the same manner as the first light source 130, the light quantity or intensity of the second light source 140 may be adjusted. Therefore, as light quantity or intensity of the second light source 140 gradually increases, brightness of the storage space 11 may gradually increase. Such change of the light quantity and intensity may be interlocked with change of the distance between the user and the cooler 1 so as to adjust brightness of the storage space 11. In more detail, as the distance between the user and the cooler 1 gradually increases, the light quantity or intensity of the second light source 140 may gradually decrease and the storage space 11 may have gradually decreased brightness so that information on the display 110 may be clearly seen. Further, as the distance between the user and the cooler 1 is gradually decreased, the light quantity or intensity of the second light source 140 may gradually increase and the storage space 11 may have gradually increased brightness so that the inside of the cooler 1 may be clearly seen. Moreover, such control of brightness may be applied based on a predetermined distance between the user and the cooler 1. In more detail, as the distance between the user and the cooler 1 gradually decreases from the above predetermined distance the light quantity or intensity of the second light source 140 may gradually increase and brightness of the storage space 11 may gradually increase. On the other hand, as the distance between the user and the cooler 1 gradually increases from the above predetermined distance, the light quantity or intensity of the second light source 140 may gradually decrease and brightness of the storage space 11 may gradually decrease.

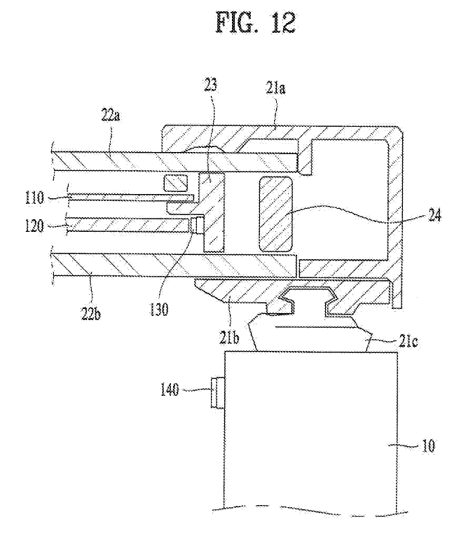

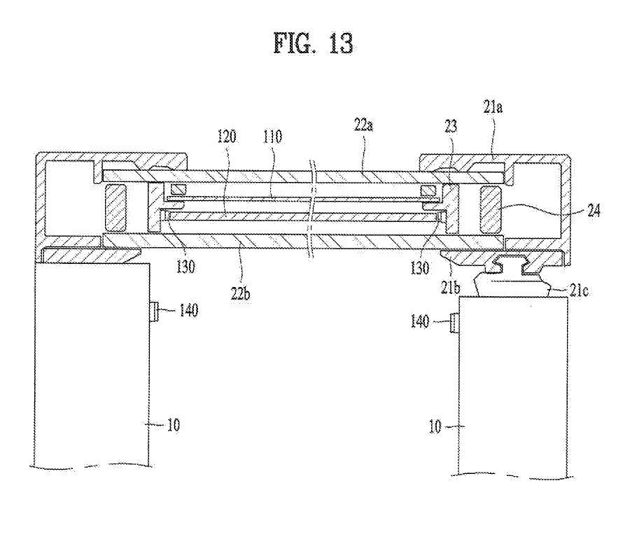

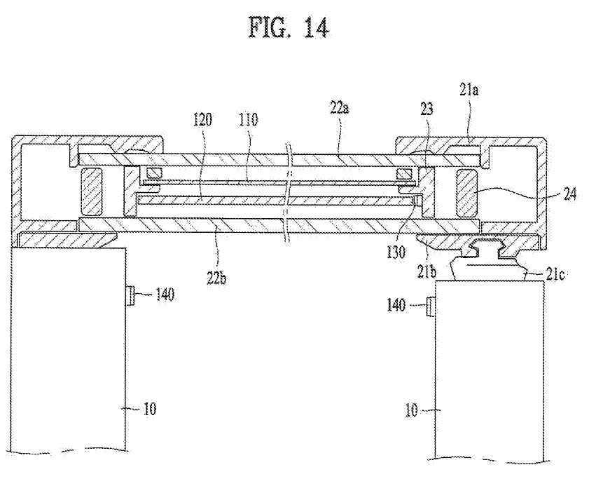

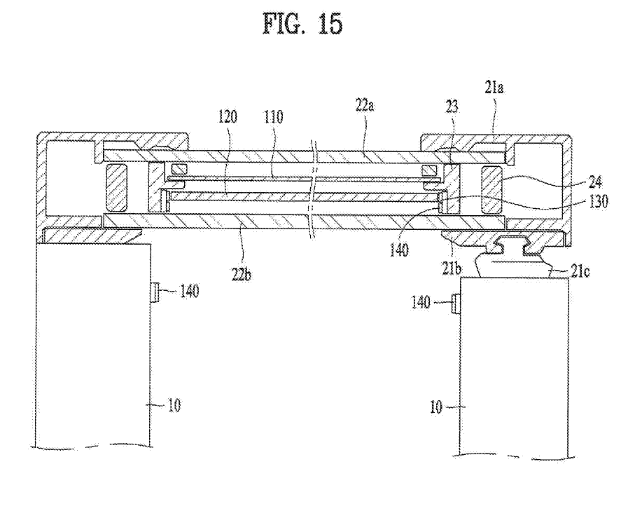

With reference to FIG. 11 second light sources 140 may be disposed at both sides of the inner space of the door 20. Therefore, the storage space 11 may be more brightly illuminated due to an increased number of the second light sources 140. Further, as exemplarily shown in FIG. 12, the second light source 140 may be disposed at the outside of the door 20. In this case, the second light source 140 may be disposed in the inner space of the cooler 1 so as to achieve more effective illumination. For example, the second light source 140 may be installed on the side wall of the body 10. For the reasons described in FIG. 11 with reference to FIG. 13, the second light sources 140 may be respectively disposed at both sides of the inner space of the cooler 1. Further, as exemplarily shown in FIG. 14, even if only one first light source 130 is installed, a plurality of second light sources 140 may be installed on the cooler 1. Moreover, as exemplarily shown in FIG. 15, a plurality of second light sources 140 may be disposed in each of the inside of the door 140 and inside of the cooler 1, i.e., the storage space 11 and, in this case, when the user is located close to the cooler 1, maximum brightness is provided to the inside of the storage space 11 and thus visibility of the storage space 11 may be greatly improved.

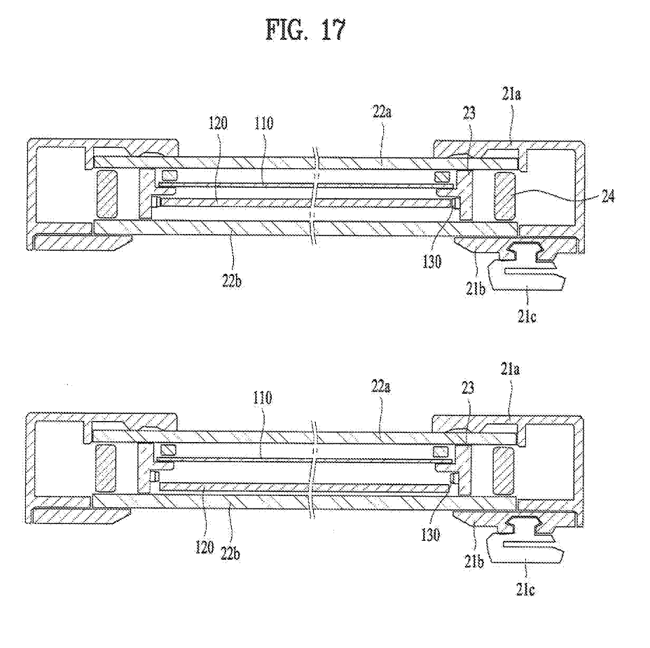

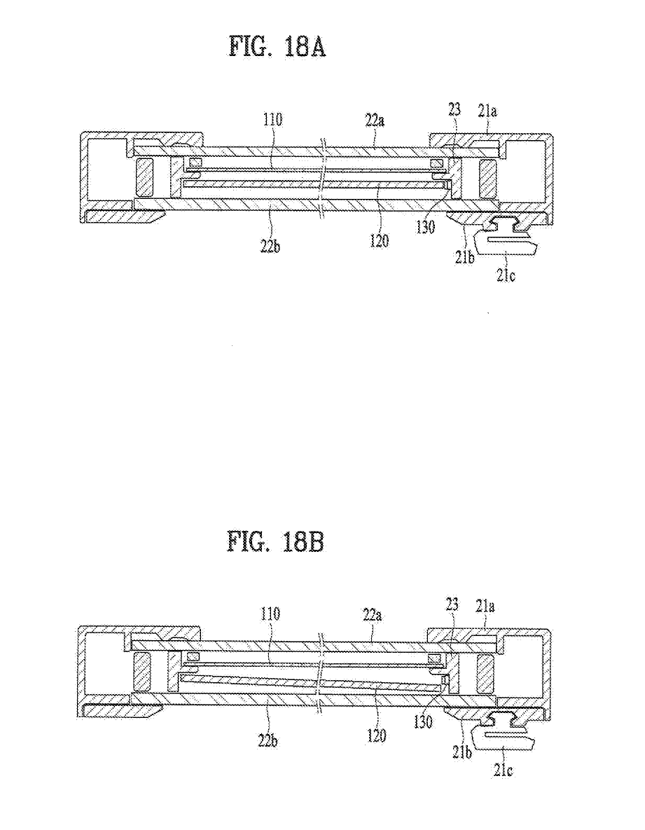

Further, in order to adjust transparency of the display assembly 100, the display assembly 100 may include a movable dispersion panel 120. FIGS. 16A and 16B are cross-sectional views of a door illustrating a display assembly including a movable dispersion panel, and FIGS. 17, 18A, and 18B are cross-sectional views illustrating other examples of the display assembly of FIGS. 16A and 16B.

First, with reference to FIGS. 16A and 16B the dispersion panel 120 may move toward the first light source 130 or move away from the first light source 130. In more detail, the display panel 120 may move forward or backward. That is, the display panel 120 may perform translational movement so as to be selectively aligned with the first light source 130. For example the display panel 120 may move backward so as not to be aligned with the first light source 130, as exemplarily shown in FIG. 16B, and move forward so as to be aligned with the first light source 130, as exemplarily shown in FIG. 16A. FIG. 17 illustrates the movement of the dispersion panel 120 shown in FIGS. 16A and 16B if first light sources 130 are provided at both sides of the dispersion panel 120. Alternatively, with reference to FIGS. 18A and 18B, the dispersion panel 120 may be rotated. The dispersion panel 120 may be rotated about one end thereof, as exemplarily shown in FIGS. 18A and 18B, or be rotated about the center thereof, i.e., the central axis thereof, although it is not shown in the drawings. For example, as exemplarily shown in FIG. 18B, the dispersion panel 120 may be rotated in a first direction so as not to be aligned with the first light source 130 and then rotated in a second direction opposite the first direction so as to be aligned with the first light source 130. As exemplarily shown in FIGS. 16B and 18B, if the dispersion panel 120 is not aligned with the first light source 130, light from the first light source 130 is not incident upon the dispersion panel 120 and the dispersion panel 120 may maintain the transparent state. On the other hand, as exemplarily shown in FIGS. 16A and 18A, if the dispersion panel 120 is aligned with the first light source 130, light from the first light source 130 is incident upon the dispersion panel 120 and transparency of the dispersion panel 120 may be reduced. For the purpose of such movement of the dispersion panel 120, various driving mechanisms, for example, a motor and a belt/gear, may be applied to the dispersion panel 120.

As described above in operation of the cooler 1 with reference to FIGS. 6 to 9, transparency of the dispersion panel 120 and transparency of the display assembly 10 thereby may be adjusted depending on the distance between a user and the cooler 1 in order to improve visibility of the storage space 11 or the display 110. In more detail, if the user is located at a predetermined distance from the cooler 1 or located farther away than the predetermined distance from the cooler 1, as exemplarily shown in FIGS. 16A and 18A, the dispersion panel 120 may move so as to be aligned with the first light source 130 and thus light from the first light source 130 may be incident upon the dispersion panel 120. Therefore, transparency of the dispersion panel 120 may be reduced and information on the display 110 may be more clearly seen by the user due to a dark background provided by the dispersion panel 120. On the other hand, if the user is located closer to the cooler 1 than the predetermined distance, as exemplarily shown in FIGS. 166 and 18B, the dispersion panel 120 may move so as not to be aligned with the first light source 130 and thus light from the first light source 130 may not be incident upon the dispersion panel 120. Therefore, the dispersion panel 120 may maintain the transparent state and the user may more clearly see the inside of the cooler 1 through the transparent display 110 and the dispersion panel 120. Consequently, as described above, in order to adjust transparency of the dispersion panel 120 and the display assembly 100 the dispersion panel 120 may move toward the first light source 130 or move away from the first light source 130 depending on the distance between the user and the cooler 1.

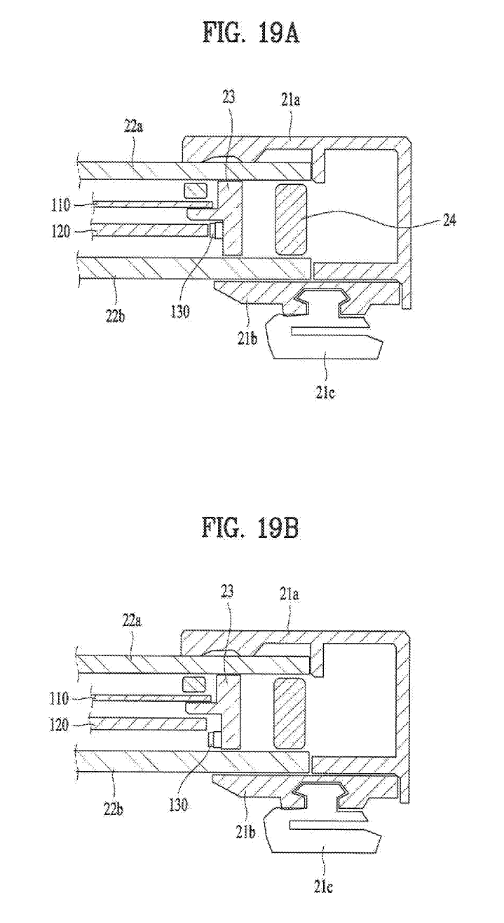

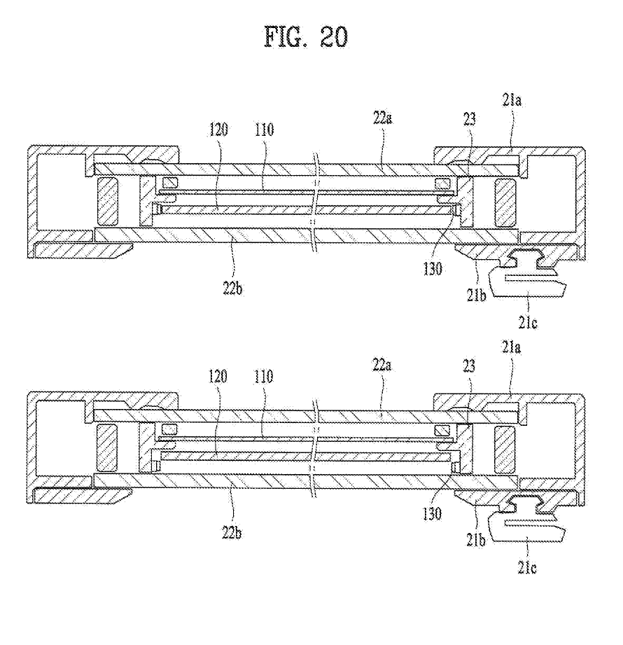

Further, in order to control transparency of the display assembly 100, the display assembly may include a first movable light source 130. FIGS. 19A and 19B are cross-sectional views of a door illustrating a display assembly including a first movable light source, and FIG. 20 is a cross-sectional view illustrating another example of the display assembly of FIGS. 19A and 19B.

First, with reference to FIGS. 19A and 19B, the first light source 130 may move toward the dispersion panel 120 or move away from the dispersion panel 120. In more detail, the first light source 130 may move forward or backward. That is, the first light source 130 may perform translational movement so as to be selectively aligned with the dispersion panel 120. For example, the first light source 130 may move backward so as not to be aligned with the dispersion panel 120, as exemplarily shown in FIG. 19B, and move forward so as to be aligned with the dispersion panel 120, as exemplarily shown in FIG. 19A. As exemplarily shown in FIG. 20, if first light sources 130 are provided at both sides of the dispersion panel 120, a pair of first light sources 130 may simultaneously perform the movement shown in FIGS. 16A and 16B. As exemplarily shown in FIG. 19B, if the first light source 130 is not aligned with the dispersion panel 120, light from the first light source 130 may not be incident upon the dispersion panel 120 and the dispersion panel 120 may maintain the transparent state. On the other hand, as exemplarily shown in FIG. 19A, if the first light source 130 is aligned with the dispersion panel 120, light from the first light source 130 may be incident upon the dispersion panel 120 and transparency of the dispersion panel 120 may be reduced. For the purpose of such movement of the first light source 130, various driving mechanisms, for example a motor and a belt/gear, may be applied to the first light source 130.

In the same manner as the above-described movable dispersion panel 120 the first movable light source 130 may be used to adjust transparency of the dispersion panel 120 and transparency of the display assembly 100 thereby depending on the distance between a user and the cooler 1. In more detail, if the user is located at a predetermined distance from the cooler 1 or located farther away than the predetermined distance from the cooler 1, as exemplarily shown in FIG. 19A, the first light source 130 may move so as to be aligned with the dispersion panel 120 and thus light from the first light source 130 may be incident upon the dispersion panel 120. Therefore, transparency of the dispersion panel 120 may be reduced and information on the display 110 may be more clearly seen by the user due to a dark background provided by the dispersion panel 120. On the other hand, if the user is located closer to the cooler 1 than the predetermined distance, as exemplarily shown in FIG. 19B, the first light source 130 may move so as not to be aligned with the dispersion panel 120 and thus light from the first light source 130 may not be incident upon the dispersion panel 120. Therefore, the dispersion panel 120 may maintain the transparent state and the user may more dearly see the inside of the cooler 1 through the transparent display 110 and dispersion panel 120. Consequently, as described above, in order to adjust transparency of the dispersion panel 120 and the display assembly 100 the first light source 130 may move toward the dispersion panel 120 or move away from the dispersion panel 120 depending on the distance between the user and the cooler 1.

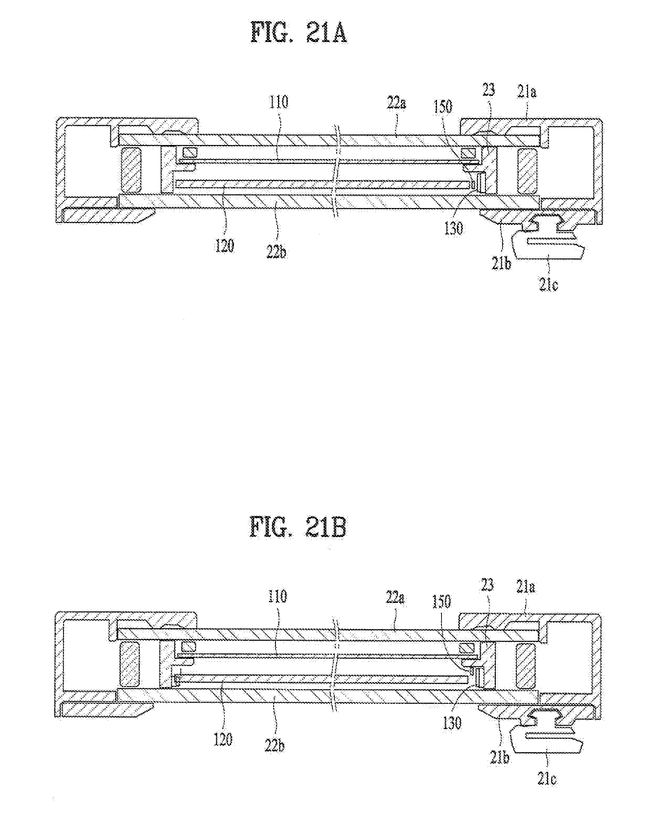

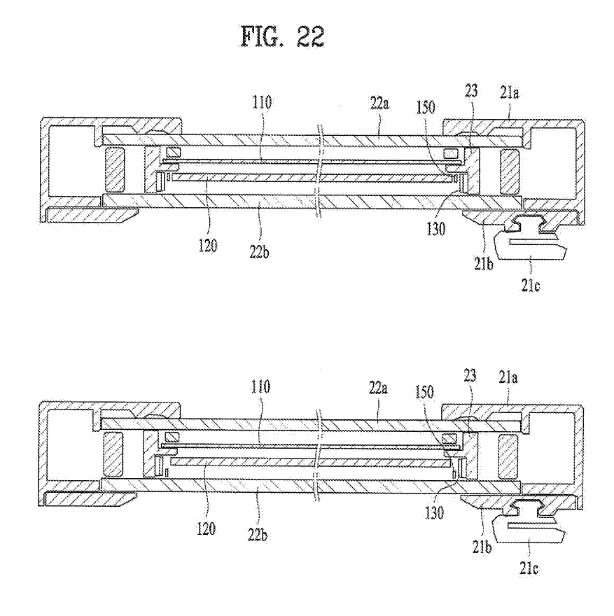

Further, in order to adjust transparency of the display assembly 100 the display assembly 100 may include a movable partition 150. FIGS. 21A and 21B are cross-sectional views illustrating a display assembly including a partition, and FIG. 22 is a cross-sectional view illustrating another example of the display assembly of FIGS. 21A and 21B.

First, with reference to FIGS. 21A and 21B, the partition 150 may move toward the dispersion panel 120 and the first light source 130 or move away from the dispersion panel 120 and the first light source 130. In more detail, the partition 150 may move forward or backward and thus be inserted into a clearance between the dispersion panel 120 and the light source 130 or withdrawn from the clearance. Due to such insertion and withdrawal of the partition 150, the partition 150 may be disposed into or removed from the clearance between the dispersion panel 120 and the first light source 130. That is, the partition 150 may perform translational movement so as to be selectively interposed between the dispersion panel 120 and the first light source 130. For example, the partition 150 may move forward so as not to be interposed between the dispersion panel 120 and the first light source 130, as exemplarily shown in FIG. 21B, and move backward so as to be interposed between the dispersion panel 120 and the first light source 130, as exemplarily shown in FIG. 21A. As exemplarily shown in FIG. 22, if first light sources 130 are provided at both sides of the dispersion panel 120, a pair of partitions 150 may be provided at both sides and simultaneously perform the movement shown in FIGS. 21A and 21B. As exemplarily shown in FIG. 21B if the partition 150 is not interposed between the dispersion panel 120 and the first light source 130, light from the first light source 130 may be incident upon the dispersion panel 120 and transparency of the dispersion panel 120 may be reduced. On the other hand as exemplarily shown in FIG. 21A, if the partition is interposed between the dispersion panel 120 and the first light source 130, light from the first light source 130 may not be incident upon the dispersion panel 120 and the dispersion panel 120 may maintain the transparent state. For the purpose of such movement of the partition 150, various driving mechanisms, for example, a motor and a belt/gear, may be applied to the partition 150.

In the same manner as the above-described movable dispersion panel 120 and first movable light source 130, the movable partition 150 may be used to adjust transparency of the dispersion panel 120 and transparency of the display assembly 100 thereby depending on the distance between a user and the cooler 1. In more detail, if the user is located at a predetermined distance from the cooler 1 or located farther away than the predetermined distance from the cooler 1, as exemplarily shown in FIG. 21B, the partition 150 is not interposed between the dispersion panel 120 and the first light source 130 and thus light from the first light source 130 may be incident upon the dispersion panel 120. Therefore, transparency of the dispersion panel 120 may be reduced and information on the display 110 may be more clearly seen by the user due to a dark background provided by the dispersion panel 120. On the other hand, if the user is located closer to the cooler 1 than the predetermined distance, as exemplarily shown in FIG. 21A, the partition 150 is interposed between the dispersion panel 120 and the first light source 130 and thus light from the first light source 130 may not be incident upon the dispersion panel 120. Therefore, the dispersion panel 120 may maintain the transparent state and the user may more clearly see the inside of the cooler 1 through the transparent display 110 and dispersion panel 120. Consequently, as described above, in order to adjust transparency of the dispersion panel 120 and the display assembly 100, the partition 150 may be selectively interposed between the dispersion panel 120 and the first light source 130 depending on the distance between the user and the cooler 1.

As described above with reference to FIGS. 16A to 22, using the movement of the dispersion panel 120, the first light source 130 and the partition 150, additional control to adjust transparency may be provided in addition to control based on on/off and intensity control of the first light source 130 described above with reference to FIGS. 6 to 9. For example, since the dispersion panel 120, the first light source 130 and the partition 150 may control incidence of light from the first light source 130 upon the dispersion panel 120, the first light source 130 may always be turned on regardless of the distance between a user and the cooler 1. In more detail, even if the user is located closer to the cooler 1 than the predetermined distance, light from the first light source 130 is not incident upon the dispersion panel 120 due to the movement of the dispersion panel 120, the first light source 130 and the partition 150 and thus both the first and second light sources 130 and 140 may be operated without the concern of decreased visibility of the storage space 11. Therefore, the first light source 130 together with the second light source 140 may radiate light to the inside of the cooler 1 and brightness of the inside of the cooler 1 may be greatly increased so that stored products may be clearly seen by the user.

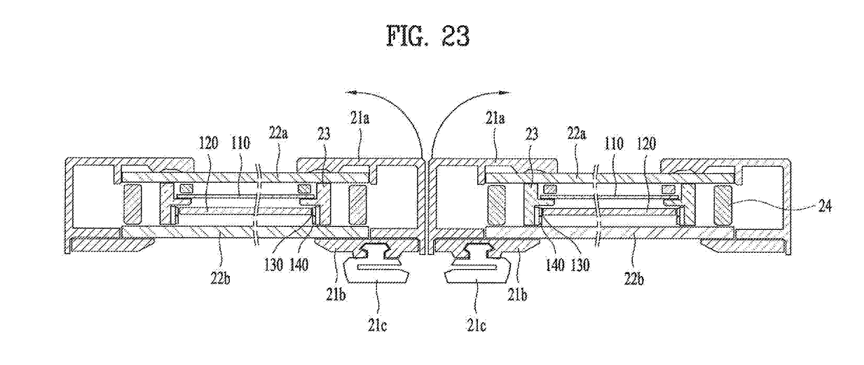

Various types of doors 20 including the above described display assembly 100 may be provided to the cooler 1. FIGS. 23 to 25 are cross-sectional views Illustrating various examples of doors, each of which includes a display assembly.

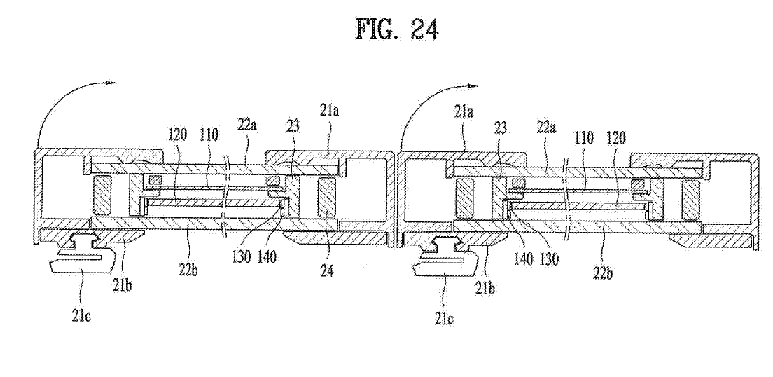

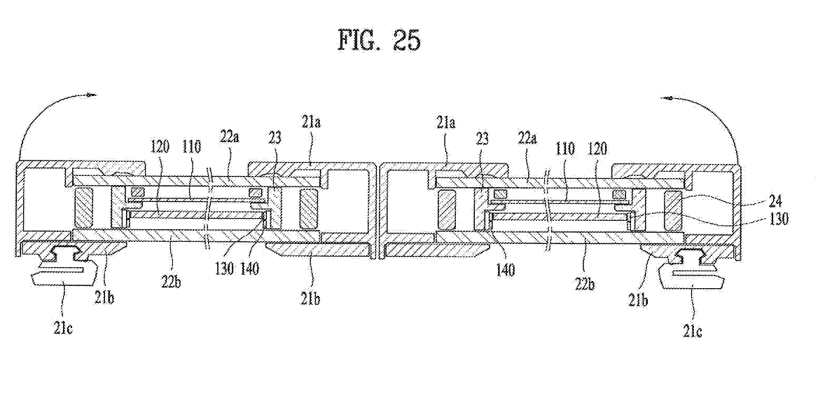

Differently from the structure of the cooler 1 shown in FIG. 1, the cooler 1 may include a plurality of doors 20 as exemplarily shown in FIGS. 23 to 25. First, with reference to FIG. 23, a pair of doors 20 may be rotatably connected to both ends of the cooler 1 and be rotated in opposite directions so as to be opened. Further, with reference to FIG. 24, one door 20 may be rotatably connected to one of both ends of the cooler 1 and the other door 20 may be rotatably connected to the central part of the cooler 1. Therefore, the two doors 20 may be rotated in the same direction so as to be opened, as exemplarily shown in FIG. 24. In addition, with reference to FIG. 25, a pair of doors 20 may be rotatably connected to the central part of the cooler 1 and be rotated in opposite directions so as to be opened.

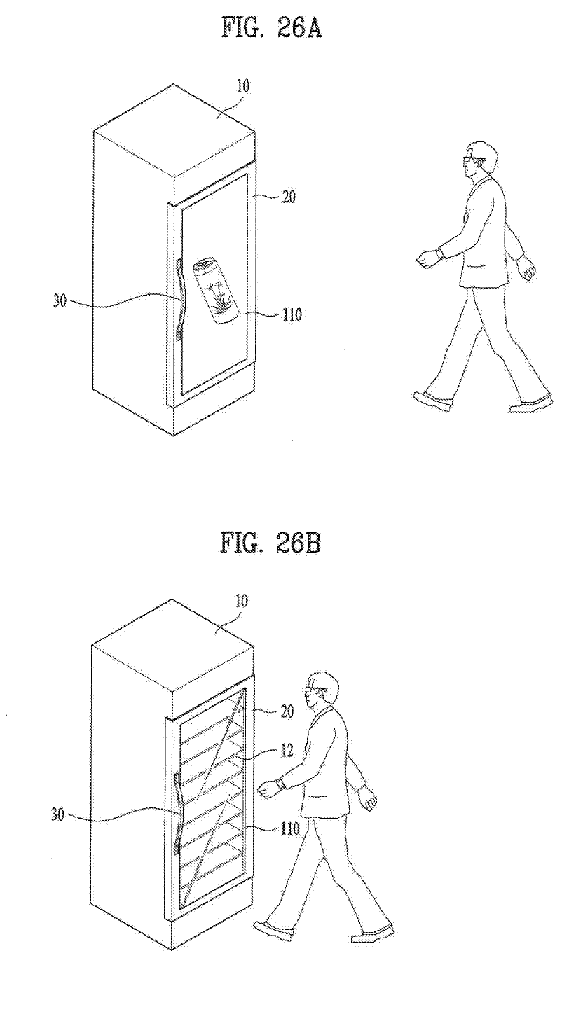

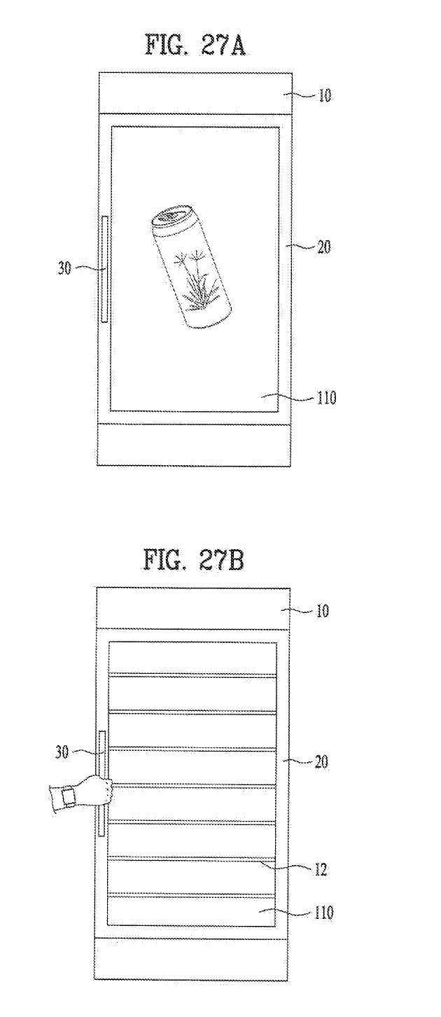

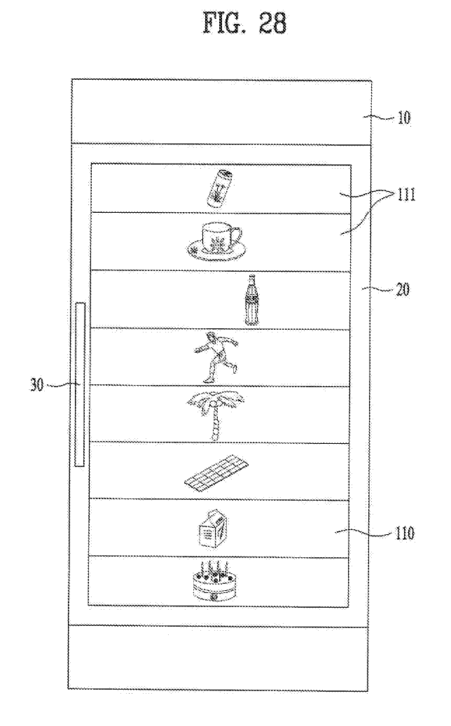

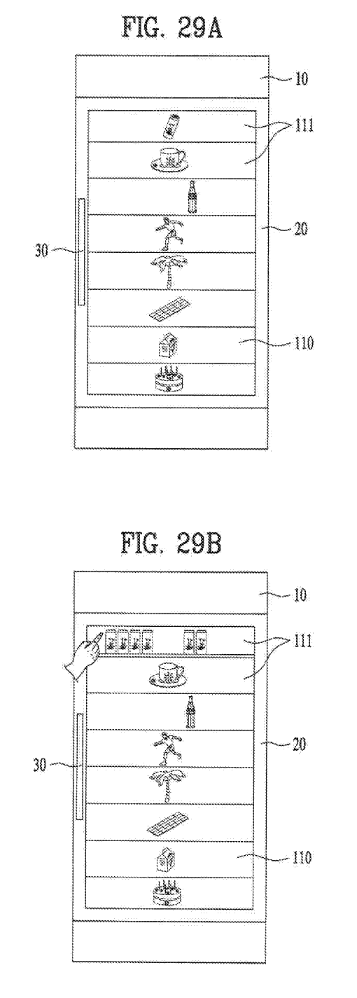

The cooler 1 may be operated through various methods using the above-described display assembly 100. FIGS. 26A and 26B are perspective views illustrating operation of the cooler depending on a distance from a user, FIGS. 27A and 27B are perspective views illustrating a further example of the cooler and operation thereof, FIG. 28 is a perspective view illustrating another example of the cooler and operation thereof, and FIGS. 29A and 29B are perspective views illustrating yet another example of the cooler and operation thereof. With reference to FIGS. 26A to 29B, various operations of coolers will be described below.

First, with reference to FIGS. 26A and 26B, the cooler 1 may include a distance sensor similar to the sensor 180 shown in FIGS. 3 and 4. As exemplarily shown in FIG. 26A, if a user is located at a predetermined distance from the cooler 1 or located farther away than the predetermined distance from the cooler 1, the first light source 130 is turned on, transparency of the dispersion panel 120 is reduced and thus information on the display 110 may be clearly seen by the user. Further, as exemplarily shown in FIG. 26B, if a user is located closer to the cooler 1 than the predetermined distance the first light source 130 is turned off, the dispersion panel 120 maintains the transparent state and thus the inside of the storage space 11 may be clearly seen by the user. Such operation of the cooler 1 shown in FIGS. 26A and 26B is similar to the operation described above with reference to FIGS. 6 to 9 and a detailed description thereof will thus be omitted.

With reference to FIGS. 27A and 27B, the cooler 1 may include a handle 30 installed on the door 20 and a sensor to sense a user touch may be installed on the handle 30 As exemplary shown in FIG. 27A if a user is located apart from the cooler 1 or does not grip the handle 30, the first light source 130 is turned on, transparency of the dispersion panel 120 is reduced and thus information on the display 110 may be clearly seen by the user. On the other hand, as exemplarily shown in FIG. 27B, if the user grips the handle 30, the controller may sense user contact through the sensor and control operation of the first light source 130. In more detail, the controller may turn off the first light source 130. Therefore, the dispersion panel 120 maintains the transparent state and thus the inside of the storage space 11 may be clearly seen by the user.

With reference to FIG. 28, the display 110 may display an image divided into a plurality of regions 111 Further, these regions 111 may correspond to respective racks 12 located behind the regions 111. Therefore, one region 111 may provide information regarding products arranged on the corresponding rack 12. For example, the region 111 may display advertisements, prices, manufacturing dates, etc. of corresponding products and other related products. Therefore, before a user substantially checks products in the storage space 12, the user may recognize the products and acquire information thereof. As described above with reference to FIGS. 6 to 9, if the user is located at a predetermined distance from the cooler 1 or located farther away from the cooler 1 than the predetermined distance, the regions 111 may provide the user with information regarding products arranged on the corresponding racks 12. In this case, the first light source 130 is turned on transparency of the dispersion panel 120 is reduced and thus information of the regions 111 may more clearly seen by the user. Further, if the user is located closer to the cooler 1 than the predetermined distance, the first light source 130 is turned off, the dispersion panel 120 maintains the transparent state and thus the inside of the storage space 11 may be clearly seen by the user. Therefore, the user may see the products on the corresponding racks 12 with his/her own eyes.

Furthermore, as exemplarily shown in FIGS. 29A and 29B, the cooler 1 shown in FIG. 28 may include a door including a sensor to sense a user touch. The sensor may be installed on the front glass 22a of the door 20 exposed to users and be interlocked with the assembly 10 and the controller located within the door 20. As exemplarily shown in FIG. 29A, if a user is located apart from the cooler 1 or does not touch the front glass 22a, the first light source 130 is turned on, transparency of the dispersion panel 120 is reduced and thus information on the display 110 may be clearly seen by the user. In this case, the regions 111 may provide information regarding products on the corresponding racks 12 to the user, as described above. On the other hand, if the a user touches the front glass 22a, the controller senses user contact through the sensor and may thus control operation of the first light source 130. In more detail, the controller may turn off the first light source 130. Therefore, the dispersion panel 120 maintains the transparent state and thus the inside of the storage space 11 may be clearly seen by the user. Further, the controller may increase transparency of only a region 111 corresponding to a region of the front glass 22a touched by the user, i.e., a selected region 111. In more detail, the first light source 130 may radiate light only to a portion of the dispersion panel 120 corresponding to the selected region 111, i.e., overlapping the selected region 111 and thus only the portion of the dispersion panel 120 may become transparent. Therefore, the user may first acquire information regarding products and then substantially see only a desired product by selection though touch.

A cooler according to embodiments may have at least the following advantages.

The cooler may control transparency of the dispersion panel depending on a distance between a user and the cooler, and may also control whether products therein are seen by the user. In accordance with such controls, the products in the cooler or information of the transparent display assembly may be selectively seen byte user. Therefore, when the user is located to be far away from the cooler, predetermined information may be clearly seen by the user to stimulate a purchasing intention by the user, and when the user is located to be close to the cooler, the products in the cooler may be clearly seen by the user clearly to assist product selection by the user. As a result, the cooler according to embodiments may control the transparent display assembly optimally, whereby efficiency may be maximized.

Further scope of applicability of the embodiments will become apparent from the detailed description. However, it should be understood that the detailed description and specific examples, while indicating embodiments, are given by illustration only, as various changes and modifications within the spirit and scope will become apparent to those skilled in the art from this detailed description.

It will be apparent to those skilled in the art that the embodiments disclosed herein can be embodied in other specific forms without departing from the spirit and essential characteristics. Thus the above embodiments are to be considered in all respects as illustrative and not restrictive. The scope should be determined by reasonable interpretation of the appended claims and all change which comes within the equivalent scope of the specification are included in the scope of the specification.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature structure or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope o, the disclosure, the drawings and the appended claims. In addition to variations and modifications in the component parts and/or arrangements, alternative uses will also be apparent to those skilled in the art.

What is claimed is:

1. A cooler having a transparent display, the cooler comprising:
a body having a storage space configured to receive products therein
a door installed on the body to open and close the storage space; and
a display assembly installed in the door, the display assembly comprising:
a transparent display panel;
a dispersion panel arranged at a rear of the transparent display panel and configured to scatter light, which is incident upon the dispersion panel;
a first light source configured to radiate light to an inside of the dispersion panel, wherein transparency of the dispersion panel is controlled via the first light source depending on a distance between the cooler and an object located outside the cooler; and
a second light source configured to radiate light to control brightness in the storage space, depending on the distance between the object and the cooler.

2. The cooler according to claim 1, wherein an operation of the first light source is determined depending on the distance between the object and the cooler, and wherein the transparency of the dispersion panel is adjusted depending on the operation of the first light source.

3. The cooler according to claim 1 wherein, if the object is located at a predetermined distance from the cooler or located farther away than the predetermined distance, the display assembly is configured to have decreased transparency, and if the object is located closer to the cooler than the predetermined distance, the display assembly is transparent.

4. The cooler according to claim 1 wherein, if the object is located at a predetermined distance from the cooler or located farther away than the predetermined distance, the first light source is configured to radiate light to the dispersion panel and the dispersion pan& has decreased transparency due to the radiated light, and if the object is located closer to the cooler than the predetermined distance, the first light source is configured so as not to radiate light, and the dispersion panel maintains its transparent state.

5. The cooler according to claim 1, wherein, if the first light source radiates light to the dispersion panel, the dispersion panel is configured to scatter the light radiated thereinto and thus have decreased transparency.

6. The cooler according to claim 1, wherein the dispersion panel is made of a transparent material, and is configured so as not to generate scattering of any light, thereby maintaining transparency if there is no light directly incident upon the dispersion panel.

7. The cooler according to claim 1, wherein, if the object is located at a predetermined distance from the cooler or located farther away than the predetermined distance, the display assembly has decreased transparency, and the products are covered by the dispersion panel to prevent the product from being seen by an user, and the object is located closer to the cooler than the predetermined distance, the display assembly is transparent and the products are viewable by the user through the transparent display panel and the dispersion panel.

8. The cooler according to claim 1, further comprising a proximity sensors at measures the distance between the object and the cooler.

9. The cooler according to claim 1, wherein the dispersion panel includes:
a body made of a first material; and
particles arranged in the body and made of a second material having a refractive index different from a refractive index of the first material.

10. The cooler according to claim 1 wherein the dispersion panel includes;
a body made of a first material; and
a layer disposed on a surface of the body and made of a second material having a refractive index different from a refractive index of the first material.

11. The cooler according to claim 9, wherein the particles are configured to scatter light, which is radiated from the light source, into the dispersion panel, due to the refractive index different from the refractive index of the body.

12. The cooler according to claim 9, wherein the first and second materials are transparent, and are configured to continue to maintain a transparent state if there is no light directly incident upon the dispersion panel.

13. The cooler according to claim 1, wherein, if the object is located at a predetermined distance from the cooler or located farther away than the predetermined distance, the display assembly is configured to provide information on the products kept the cooler and/or information of a product which is not kept in the cooler.

14. The cooler according to claim 1, wherein, if the object is located closer to the cooler than the predetermined distance, the display assembly provides only information on the products kept in the cooler or does not provide any information.

15. The cooler according to claim 1, wherein an operation of the second light source is determined depending on the distance between the object and the cooler, and wherein the brightness of the storage space is adjusted depending on the operation of the second light source.

16. The cooler according to claim 1, wherein the second light source is configured to radiate the light while the first light source is deactivated.

17. The cooler according to claim 1 wherein, if the object is located at a predetermined distance from the cooler or located farther away than the predetermined distance, the second light source is configured not to radiate light, and the storage space has reduced brightness, and if the object is located closer to the cooler than the predetermined distance, the second light source is configured to radiate light to the storage space and the storage space has increased transparency due to the radiated light.

18. The cooler according to claim 1, wherein the dispersion panel is further configured to move toward or away from the first light source depending on the distance between the object and the cooler so as to adjust the transparency of the dispersion panel.

19. The cooler according to claim 18, wherein the dispersion panel is configured to make a translational movement or a rotational movement.

20. The cooler according to claim 18, wherein the if the object is located at a predetermined distance from the cooler or located farther away than the predetermined distance, the dispersion panel is moved to be aligned with the first light source such that the light radiated by the first light source is able to be incident upon the dispersion panel, and if the object is located be closer to the cooler than the predetermined distance, the dispersion panel is moved to not be aligned with the first light source such that there is no light directly incident upon the dispersion panel

21. The cooler according to claim 1, wherein the first light source is further configured to move toward or away from the dispersion panel depending on the distance between the object and the cooler so as to adjust the transparency of the dispersion panel.

22. The cooler according to claim 21, wherein the if the object is located at a predetermined distance from the cooler or located farther away than the predetermined distance the first light source is moved to be aligned with the dispersion panel such that the light radiated by the first light source is able to be incident upon the dispersion panel, and if the object is located be closer to the cooler than the predetermined distance the first light source is moved to not be aligned with the dispersion panel such that there is no light directly incident upon the dispersion panel.

23. The cooler according to claim 1, further comprising a partition configured to be selectively interposed between the dispersion panel and the first light source depending on the distance between the object and the cooler.

24. The cooler according to claim 21, wherein the if the object is located at a predetermined distance from the cooler or located farther away than the predetermined distance, the partition is not disposed between the dispersion panel and the first light source such that the light radiated by the first light source is able to be incident upon the dispersion panel, and if the object is located be closer to the cooler than the predetermined distance, the partition is disposed between the dispersion panel and the first light source such that there is no light directly incident upon the dispersion panel.
